(19) United States
(12) Patent Application Publication
(10) Pub. No.: US 2023/0130201 A1
(43) Pub. Date: Apr. 27, 2023

(54) DRIVER SEAT AND SIDE MIRROR-BASED LOCALIZATION OF 3D DRIVER HEAD POSITION FOR OPTIMIZING DRIVER ASSIST FUNCTIONS

(71) Applicant: GM GLOBAL TECHNOLOGY OPERATIONS LLC, Detroit, MI (US)

(72) Inventors: Xu Fang Zhao, LaSalle (CA); Gaurav Talwar, Novi, MI (US); Alaa M. Khamis, Courtice (CA)

(73) Assignee: GM GLOBAL TECHNOLOGY OPERATIONS LLC, Detroit, MI (US)

(21) Appl. No.: 17/510,568

(22) Filed: Oct. 26, 2021

(51) Int. Cl. B60W 40/09; G06K 9/00

(52) U.S. Cl. CPC B60W 40/09; G06K 9/00845; B60W 2420/42; B60W 2040/0881

(57) ABSTRACT

A motor vehicle includes a body defining a passenger compartment and having opposing driver and passenger sides. The vehicle includes driver and passenger side mirrors. The driver side mirror has a sweep angle (α) and an elevation angle (γ). The passenger side mirror has a sweep angle (β). The side mirrors are separated from each other by a distance (D). An adjustable driver seat has a height (H). An electronic controller, in response to position signals inclusive of angles (α), (β), and (γ), the distance (D), and the height (H), calculates a three-dimensional (3D) driver head position of a driver of the vehicle, and thereafter uses the 3D driver head position to improve performance of a driver assist system device. Functions of the controller may be implemented as a method or recorded on a computer readable medium for execution by a processor.

### INTRODUCTION

The present disclosure relates to automated electronic controller-based strategies for localizing a position of a vehicle driver's head in a defined three-dimensional (3D) space, and for thereafter using the localized head position to perform or augment one or more downstream driver assist functions aboard a motor vehicle or another operator-driven mobile platform.

The location of a vehicle driver within a cabin or passenger compartment of a motor vehicle is often required when performing a wide array of driver assist functions. For example, motor vehicles are often equipped with automated speech recognition capabilities suitable for performing various hands-free telephonic, infotainment, or navigation operations, or when commanding associated functions of a virtual assistant. Additionally, higher trim vehicle models may include advanced vision systems, and thus may include a suite of cameras, sensors, and artificial intelligence/image interpretation software. Vision systems may also be configured to detect and track the driver's pupil position in a collected set of images for the purpose of tracking the driver's line of sight, e.g., when monitoring for distracted, drowsy, or otherwise impaired driver operating states.

### SUMMARY

The present disclosure pertains to automated electronic controller-based systems and methods for use aboard a motor vehicle to localize a three-dimensional (3D) position of a driver's head within a defined space of a passenger compartment. The localized position, referred to hereinafter as a 3D driver head position for clarity, may be used by one or more downstream driver assist functions. For example, the efficiency and/or accuracy of various downstream applications and onboard automated functions may be assisted by accurate foreknowledge of the 3D driver head position. Exemplary functions contemplated herein may include acoustic beamforming and other digital signal processing techniques used to detect and interpret speech when executing “hands free” control actions aboard the motor vehicle. Likewise, automated gaze detection and other driver monitoring system (DMS) devices may benefit from improved levels of accuracy as enabled by the present teachings. These and other representative driver assist functions are described in greater detail below.

In an aspect of the present disclosure, the motor vehicle is equipped with adjustable external side mirrors and an adjustable driver seat, i.e., a multi-axis power driver seat. The side mirrors and the seat are configured with respective position sensors as appreciated in the art. With respect to the side mirrors, the position sensors are typically integrated into mirror mounting and motion control structure and configured to measure and output corresponding multi-axis position signals indicative of the mirror's present angular position. Particular angular positions considered herein include a horizontal/left-right sweep angle and a vertical/up-down elevation angle, i.e., tilt angle. The seat sensor for its part measures and outputs a position signal indicative of the seat's current height setting relative to a baseline position, e.g., relative to a floor pan level or another lowest height setting.

As part of the disclosed control strategy, the onboard electronic controller is programmed with a calibrated linear distance of separation between the opposing side mirrors. The electronic controller processes the above-noted position signals and the calibrated distance between the side mirrors to calculate the 3D driver head position. In some implementations, the electronic controller outputs a numeric triplet value [x, y, z] corresponding to a nominal x-position, y-position, and z-position within a representative xyz Cartesian frame of reference. Logic blocks for more onboard driver assist systems, with such logic blocks taking the form of programmed software-based functions and associated hardware, receive the 3D driver head position and thereafter execute one or more corresponding control functions aboard the motor vehicle.

In a possible sequential implementation of the present method using the above-summarized numeric triplet value, the electronic controller first calculates the x-position as a function of the reported mirror sweep angles and the calibrated distance of separation (D) between the opposing driver and passenger side mirrors. For clarity, the sweep angles are represented hereinafter as angles α and β for the side mirrors disposed on the driver-side and passenger-side of the motor vehicle, respectively. Thereafter, the controller calculates the y-position as a function of the sweep angle (α) of the driver side mirror and the calculated x-position. The z-position in turn may be calculated as a function of the seat height (H), the x-position, and an elevation angle (γ) of the driver side mirror.

Further with respect to mathematical embodiments usable for calculating the 3D driver head position, the electronic controller may calculate the x-position of the driver's head, represented herein as Pₓ, using the following equation:

$${P}_{x} = D \frac{tan ( β )}{tan ( α ) + tan ( β )}$$

In turn, the y-position (P_{y}) may be calculated by multiplying the aforementioned x-position by the tangent (tan) of the driver side sweep angle (α), i.e., P_{y}=Pₓ tan(α). The z-position (P_{z}) may be calculated from the current seat height (H), the x-position (Px), the sweep angle (α), and the elevation angle (γ) of the driver side adjustable side mirror, which in this implementation is represented mathematically as:

$${P}_{z} = H + \frac{{P}_{x}}{cos ( α )} \cdot tan ( γ )$$

In a possible configuration, the motor vehicle includes an array of in-vehicle microphones (“microphone array”). The microphone array is coupled to an acoustic beamforming block configured to process received acoustic signatures from the individual microphones, and to thereby increase a signal to noise ratio and modify a focus direction of a particular microphone or microphones within the microphone array. In such an embodiment, the electronic controller feeds the calculated 3D driver head position, e.g., as the triplet [Pₓ, P_{y}, P_{z}], to the acoustic beamforming block. The acoustic beamforming block is configured to use the received 3D driver head position as a focused starting point when performing a speech recognition function, and may effectively steer the received acoustic beam to focus directly on the source of speech, in this instance the most likely location of the driver's mouth.

In another possible configuration, the motor vehicle includes at least one driver monitoring system (DMS) device equipped with one or more cameras. The DMS device may be optionally configured as a “gaze tracker” of the type summarized above, a facial expression recognition block, and/or another suitable vision-based application. As with the possible speech recognition system, the DMS device(s) may receive the calculated 3D driver head position from the electronic controller and thereafter use the received 3D driver head position to perform a vision-based application function. For instance, the calculated 3D driver head position may act as a control input to the DMS device(s) to limit an area of interest to be imaged by the cameras, thereby improving detection speed, performance, and relative accuracy.

A computer readable medium is also disclosed herein, on which instructions are recorded for localizing the 3D driver head position. In such an embodiment, execution of the instructions by at least one processor of the electronic controller causes the electronic controller to perform the above-summarized method.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a plan view illustration of a representative motor vehicle having an electronic controller configured to optimize onboard driver assistance functions using a three dimensional (3D) driver head position derived from driver seat and adjustable side mirror settings in accordance with the present disclosure.

FIG. 1A illustrates a driver side mirror, in plan view, of the motor vehicle shown in FIG. 1.

FIG. 2 is a side view illustration of the motor vehicle shown in FIG. 1.

FIG. 3 is a flow diagram describing a possible implementation of a control method for use aboard the representative motor vehicle of FIGS. 1 and 2.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

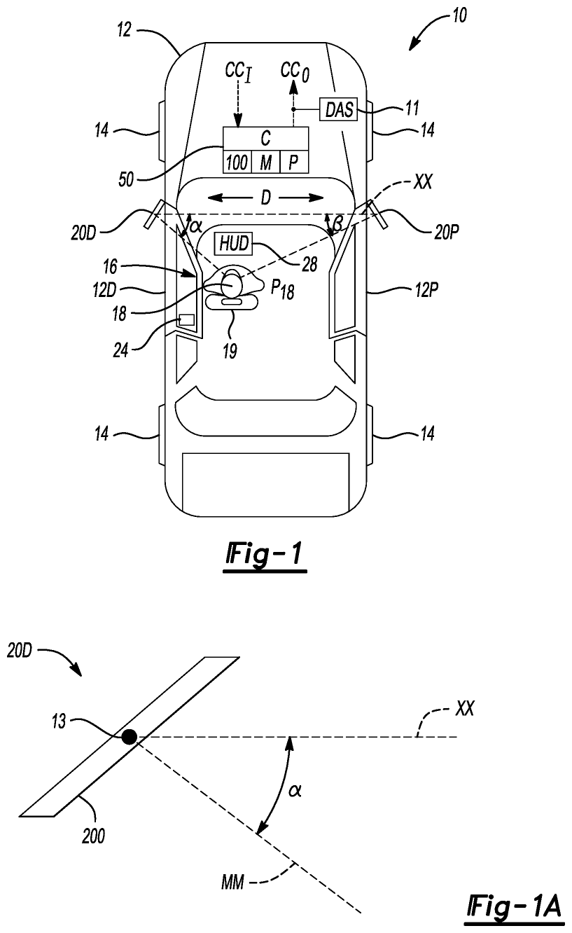

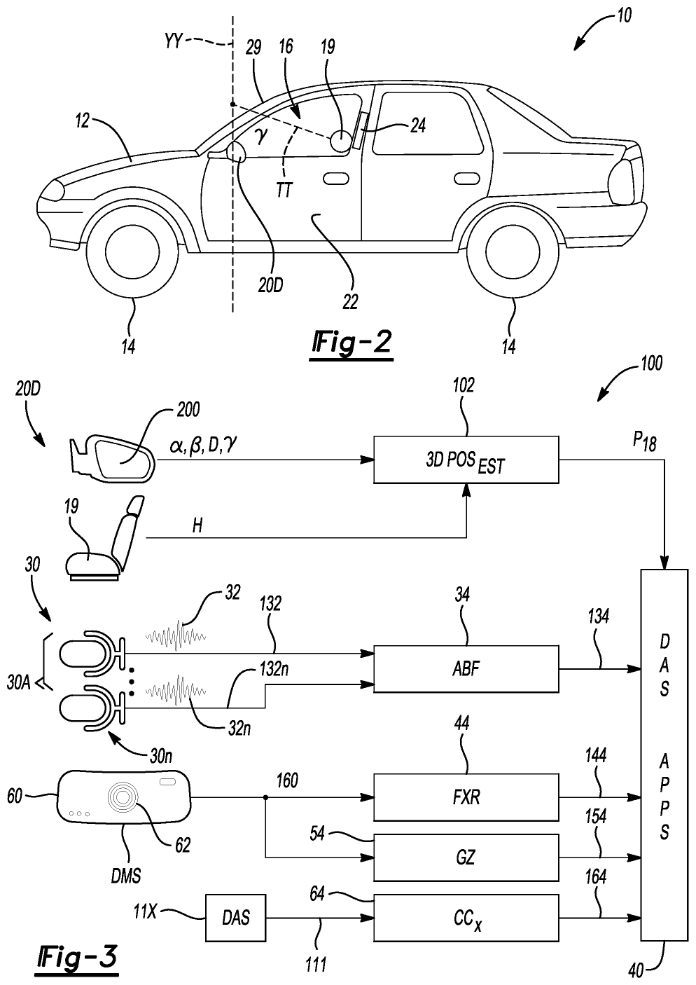

Referring to the drawings, wherein like reference numbers refer to like features throughout the several views, FIG. 1 is a plan view illustration of a representative motor vehicle 10 having a vehicle body 12 and road wheels 14. The vehicle body 12 defines a passenger compartment 16, with the motor vehicle 10 being operated by a driver 18 seated on a power adjustable driver seat 19 located therewithin. Although the motor vehicle 10 is depicted as a passenger sedan having four of the road wheels 14 for illustrative purposes, the present teachings may be extended to a wide range of mobile platforms operated by the driver 18, including trucks, crossover or sport utility vehicles, farm equipment, forklifts or other plant equipment, and the like, with more or fewer than four of the road wheels 14 being used in possible configurations of the motor vehicle 10. Therefore, the specific embodiment of FIGS. 1 and 2 is illustrative of just one type of motor vehicle 10 benefitting from the present teachings.

The vehicle body 12 includes a driver side 12D and a passenger side 12P. As shown in the representative embodiment of the motor vehicle 10 shown in FIG. 1, the driver side 12D is located on the left hand side of the passenger compartment 16 relative to a forward-facing position of the driver 18. In other configurations, the motor vehicle 10 may be constructed for so called “right-side driving”, such that the driver side 12D and the passenger side 12P are reversed, i.e., the driver side 12D could be located on the right hand side of the passenger compartment 16. Thus, along with the particular body style as noted above, the motor vehicle 10 may vary in its drive configuration for operation according to the convention of a particular country or locality.

Within the scope of the present disclosure, the motor vehicle 10 includes an electronic controller (C) 50 in the form of one or more computer hardware and software devices collectively configured, i.e., programmed in software and equipped in hardware, to execute computer readable instructions embodying a method 100. In executing the present method 100, the electronic controller 50 is able to optimize one or more driver assist functions aboard the motor vehicle 10, with such functions possibly ranging from automatic speech and/or facial recognition/gaze tracking functions to direct or indirect component control actions, several examples of which are described in greater detail below.

In accordance with the present method 100, the vehicle body 12 include respective first (“driver side”) and second (“passenger side”) adjustable side mirrors 20D and 20P. The respective driver and passenger side mirrors 20D and 20P are configured as reflective panes of glass each selectively positioned by the driver 18 using a corresponding joystick or other suitable device (not shown). The driver side mirror 20D, which is connected to the driver side 12D of the vehicle body 12, has a corresponding sweep angle (α) and elevation angle (γ), both of which are measured, monitored, and reported to the electronic controller 50 as part of a set of position signals (arrow CO over the vehicle communications bus, e.g., a controller area network (CAN) bus as appreciated in the art, in the course of operation of the motor vehicle 10.

Referring briefly to FIG. 1A, the driver side mirror 20D includes a midpoint 13 and an orthogonal centerline MM, with the sweep angle (α) being defined between a lateral axis (xx) of the motor vehicle 10 and the orthogonal centerline MM as shown in FIG. 1. That is, the orthogonal centerline MM is arranged 90° relative to a mirror surface 200 of the first adjustable mirror 20D. As shown in FIG. 2, the driver side mirror 20D also tilts upward/away from or downward/toward from the driver 18, with the particular angular orientation of the driver side mirror 20D being the elevation angle (γ). That is, the contemplated elevation angle (γ) used in the performance of the method 100 is 90° minus the angle defined between a vertical axis (yy) of the driver side mirror 20D and an imaginary line TT drawn tangential to the mirror surface 200. For illustrative clarity, line TT is shown in FIG. 2 a distance apart from but parallel to the mirror surface 200.

Referring again to FIG. 1, the passenger side mirror 20P has its own sweep angle (β), which is analogous to the sweep angle (α) of the driver side mirror 20D. The passenger side mirror 20P is separated from the driver side mirror 20D by a predetermined distance of separation (D). The distance of separation (D) will be specific to a given make or model of the motor vehicle 10, i.e., a larger distance (D) typically will be used for wider motor vehicles 10 such as trucks or full size passenger sedans, with a smaller distance (D) used for smaller sedans, coupes, etc. Therefore, the particular value of the distance (D) is generally a fixed calibrated or predetermined value stored in memory (M) of the electronic controller 50 for use in performing the present method 100.

The motor vehicle 10 of FIG. 1 also includes the adjustable driver seat 19, which is connected to the vehicle body 12 and located within the passenger compartment 16. The adjustable driver seat 19 has a height (H), with the height (H) varying within a defined range based on settings selected by the driver 18. As appreciated in the art, power activation of the adjustable driver seat 19 is typically enabled by one or more electric motors or other rotary and/or linear actuators housed within or mounted below the adjustable driver seat 19 to enable the driver 18 to adjust the adjustable driver seat 19 to a comfortable driving position. In addition to the height (H), the driver 18 is typically able to select desired fore and aft positions of the driver seat 19, as well as a corresponding position of a headrest, lumbar support, etc.

The electronic controller 50 of FIG. 1 within the scope of the present disclosure is configured, in response to the position signals (arrow CO inclusive of the aforementioned sweep angles (α) and (β), the elevation angle (γ), the distance (D), and the height (H), to calculate a 3D driver head position P₁₈ of the driver 18 of the motor vehicle 10 when the driver 18 is seated within the passenger compartment 16. In a possible embodiment, the electronic controller 50 is configured to output the 3D driver head position P₁₈ as a triplet value [x, y, z] corresponding to a nominal x-position (Pₓ), a nominal y-position (P_{y}), and a nominal z-position (P_{z}) within a representative xyz Cartesian frame of reference. The 3D head position P₁₈ is then communicated to the DAS device 11 via optimization request signals (arrow CC_{O}) from the electronic controller 50.

The motor vehicle 10 as contemplated herein includes at least one driver assist system (DAS) device 11 in communication with the electronic controller 50 over hardwired transfer conductors and/or a wireless communications pathway using suitable communications protocols, e.g., a Wi-Fi protocol using a wireless local area network (LAN), IEEE 802.11, a 3G, 4G, or 5G cellular network-based protocol, BLUETOOTH, BLE BLUETOOTH, and/or other suitable protocol. Each DAS device 11 in turn is operable to execute a corresponding driver assist control function in response to the received 3D driver head position (P₁₈) as set forth herein.

Still referring to FIG. 1, the electronic controller 50 for the purposes of executing a method 100 is equipped with application-specific amounts of volatile and non-volatile memory (M) and one or more processor(s) (P). The memory (M) includes or is configured as a non-transitory computer readable storage device(s) or media, and may include volatile and nonvolatile storage in read-only memory (ROM) and random-access memory (RAM), and possibly keep-alive memory (KAM) or other persistent or non-volatile memory for storing various operating parameters while the processor (P) is powered down. Other implementations of the memory (M) may include, e.g., flash memory, solid state memory, PROM (programmable read-only memory), EPROM (electrically PROM), and/or EEPROM (electrically erasable PROM), and other electric, magnetic, and/or optical memory devices capable of storing data, at least some of which is used in the performance of the method 100. The processors (P) may include various microprocessors or central processing units, as well as associated hardware such as a digital clock or oscillator, input/output (I/O) circuitry, buffer circuitry, Application Specific Integrated Circuits (ASICs), systems-on-a-chip (SoCs), electronic circuits, and other requisite hardware needed to provide the programmed functionality. In the context of the present disclosure, the electronic controller 50 executes instructions via the processor(s) (P) to cause the electronic controller 50 to perform the method 100.

Computer readable non-transitory instructions or code embodying the method 100 and executable by the electronic controller 50 may include one or more separate software programs, each of which may include an ordered listing of executable instructions for implementing the stated logical functions, specifically including those depicted in FIG. 3 and described below. Execution of the instructions by the processor (P) in the course of operating the motor vehicle 10 of FIGS. 1 and 2 causes the processor (P) to receive and process measured position signals from the adjustable driver seat 19, i.e., from sensors integrated therewith as appreciated in the art.

Similarly, the processor (P) receives and processes measured position signals from the respective driver and passenger side mirrors 20D and 20P, as well as stored calibrated data such as the above-noted distance of separation (D) along a lateral axis (xx) extending between mirrors 20D and 20P. In response to these signals, which collectively form the position signals (arrow CO of FIG. 1, the electronic controller 50 performs calculations for deriving the 3D driver head position (P₁₈), e.g., as the numeric triplet value P[x, y, z]. Upon derivation of the 3D driver head position (P₁₈), the electronic controller 50 ultimately transmits optimization request signals (arrow CC_{O}) inclusive of/concurrently with the 3D driver head position (P₁₈) to the DAS device(s) 11, with the optimization request signals (arrow CC_{O}) serving to request use of the 3D driver head position by the DAS device 11 when performing a corresponding driver assist function, e.g., in an optimization subroutine of the DAS device 11 when performing speech and/or vision-based implementations as described below, or for controlling other vehicle devices such as a height-adjustable seat belt assembly 24, a heads up display (HUD) device 28, etc.

As noted above, the DAS device 11 shown schematically in FIG. 1 is variously embodied as an automatic speech detection and recognition device and/or an in-vehicle vision system. With respect to speech applications, the ability to accurately discern a spoken word or phrase requires knowledge of the current location of the source. To this end, the motor vehicle 10 may arrange one or more microphones 30 of a microphone array 30A (see FIG. 3) within the passenger compartment 16 in proximity to the driver 18. For simplicity, additional microphones 30 are depicted as microphone 30n, with “n” in this instance being an integer value of one or more. The particular arrangement and configuration of the microphones 30 is conducive to the proper functioning of speech recognition software, as appreciated in the art. For instance, the microphones 30 could be analog or digital. Beamforming can also be applied on multiple analog microphones 30 in some embodiments.

Moreover, digital signal processing (DSP) techniques such as acoustic beamforming may be used to shape received acoustic waveforms 32 from the various microphones 30 of the microphone array 30A shown in FIG. 3, with each of the n additional microphones 30n likewise outputting a corresponding acoustic waveform 32n. As appreciated in the art, acoustic beamforming refers to the process of delaying and summing acoustic energy from multiple acoustic waveforms 32 collected by distributed receiving microphones 30 of FIG. 3, such that a resulting acoustic waveform is ultimately shaped in a desired manner in the defined 3D acoustic space of the passenger compartment 16. Acoustic beamforming may be used, e.g., to detect an utterance by the driver 18 while filtering out or cancelling ambient noise, speech from other passengers, etc. Knowledge of the precise position of the target source of a given utterance, i.e., the 3D driver head position (P₁₈), thus allows acoustic beamforming algorithms and other signal processing subroutines to modify a focus direction of the microphone array 30A and more accurately separate the utterance source from other proximate noise sources, which in turn will help improve detection accuracy.

With respect to vision systems, modern vehicles having higher trim levels benefit from the integration of cameras and related image processing software that together identify unique characteristics of the driver 18, and that thereafter use such characteristics in the overall control of the motor vehicle 10. For example, facial recognition software may be used to estimate the cognitive state of the driver 18, such as by detecting facial expressions or other facial characteristics that may be indicative of possible drowsiness, anger, or distraction. Gaze detection is used in a similar manner to help detect and locate the pupils of the driver 18, and to thereafter calculate a line of sight of the driver 18. Refined location and orientation of the driver 18 in the motor vehicle 10 can also help improve gaze detection and task completion, providing more accurate results for voice-based virtual assistants.

In order to locate the face of the driver 18 within the passenger compartment 16, the electronic controller 50 uses setting profiles of the driver side mirrors 20D and the passenger side mirror 20P, as well as of the adjustable driver seat 19. The electronic controller 50 performs its localization functions without specialized sensors, with the electronic controller 50 instead using position data from integrated position sensors of the respective driver and passenger side mirrors 22D and 22P and the adjustable driver seat 19, i.e., data that is already customarily reported via a resident CAN bus of the motor vehicle 10.

The electronic controller 50 according to a representative embodiment is configured, for a nominal xyz Cartesian reference frame in which the electronic controller 50 derives and outputs the numeric triplet value P[x,y,z], to calculate an x-position (Pₓ) of a head of the driver 18 of FIG. 1 using the following equation:

$${P}_{x} = D \frac{tan ( β )}{tan ( α ) + tan ( β )}$$

and to calculate a y-position (P_{y}) as a function of the x-position (Pₓ). The function of the x-position (Pₓ) may be expressed mathematically as P_{y}=Pₓ tan(α), with the electronic controller 50 configured to calculate a z-position (P_{z}) as a function of the x-position (Pₓ). The function of the x-position (Pₓ) may be expressed as

$${P}_{z} = H + \frac{{P}_{χ}}{cos ( α )} \cdot tan ( γ )$$

FIG. 2 depicts the driver side 12D of the vehicle body 12. The driver side mirror 20D is arranged on a driver door 22, with the adjustable driver seat 19 located proximate the driver door 22 within the passenger compartment 16. In addition to speech recognition and vision system functions as discussed above, the motor vehicle 10 may include, as the DAS device 11 of FIG. 1, the height-adjustable seat belt assembly 24 mounted to the vehicle body 12 within the passenger compartment 16. An associated logic block, shown generically at 64 in FIG. 3 and labeled CC_{X}, is configured to adjust the height (H) of the seat belt assembly 24 as the corresponding driver assist control function in such a configuration.

In another possible embodiment, the DAS device 11 of FIG. 1 may include the HUD device 28, which in turn is positioned within the passenger compartment 16. The HUD device 28 may include the associated logic block 64 of FIG. 3, which in this instance is configured to adjust a setting of the HUD device 28 as the corresponding driver assist control function. For example, the electronic controller 50 may transmit the 3D driver head position (P₁₈) of FIG. 1 to the HUD device 28 as part of the above-noted optimization request. The HUD device 28 may respond by adjusting a brightness or dimness setting, or possibly a screen tilt angle and/or height when the HUD device 28 uses an articulating or repositionable display screen. Embodiments may be conceived in which the HUD device 28 displays information directly on the inside of a windshield 29, in which case the HUD device 28 may be configured to respond to the 3D driver head position (P₁₈) by raising or lowering the displayed information as needed for easier viewing by the driver 18.

Referring now to FIG. 3, the method 100 may be performed aboard the motor vehicle 10 of FIG. 1, which includes the vehicle body 12 defining the passenger compartment 16 as noted above, with the vehicle body 12 having respective driver and passenger sides 12D and 12P as shown in FIGS. 1 and 2. As part of the method 100, the driver side mirror 20D measures and communicates the sweep angle (α) and elevation angle (γ) to the electronic controller 50. Although omitted from FIG. 3 for illustrative simplicity, the passenger side mirror 20B similarly communicates its sweep angle (β) to the electronic controller 50, which also has knowledge of the distance of separation (D). Additional inputs to the electronic controller 50 include the reported height (H) of the adjustable driver seat 19. Thus, the method 100 commences with receipt and/or determination of the relevant starting parameters or settings, i.e., the sweep angles (α and β), the elevation angle (γ), the distance (D), and the height (H).

As part of the method 100, a 3D position estimator block 102 of the electronic controller 50, in response to input signals (arrow CC_{I} of FIG. 1) inclusive of the sweep angle (α), the sweep angle (β), the elevation angle (γ), the predetermined distance of separation (D), and the height (H), calculates the 3D head position (P₁₈) of the driver 18 shown in FIG. 1 while the driver 18 is seated within the passenger compartment 16. The 3D head position (P₁₈) is transmitted over a CAN bus connection, a differential network, or other physical or wireless transfer conductors to one or more driver assist system (DAS) applications (APPS), as represented by a DAS APP block 40. As contemplated herein, the DAS APP block 40 constitutes a suite of software in communication with one or more constituent hardware devices and configured to control an output state and/or operating function thereof during operation of the motor vehicle 10 of FIGS. 1 and 2.

As shown in FIG. 1, the motor vehicle 10 includes at least one DAS device 11 in communication with the electronic controller 50 and operable to execute a corresponding driver assist control function in response to the 3D head position (P₁₈). Among the myriad of possible devices or functions that could operate as the DAS device 11 of FIG. 1 is the function of automated speech recognition, as summarized above. Speech recognition within the passenger compartment 16 is facilitated by the microphone array 30A, with multiple directional or omni-directional microphones 30 arranged at different locations within the passenger compartment 16. Each constituent microphone 30 and 30n outputs a respective acoustic signature 32 and 32n as an electronic signal (arrows 132 and 132n), which may in some implementations be received by an acoustic beam forming (ABF) block 34 of the type described above. The ABF block 34 ultimately combines the various acoustic signatures 32 into a combined acoustic signature (arrow 134), which in turn is fed into the DAS APPS block 40 for processing thereby. Thus, the DAS 11 of FIG. 1 may include the ABF block 34 coupled to the microphone array 30A and configured to process multiple received acoustic signatures 32 therefrom. In such a use case, the ABF block 34 is configured to use the 3D head position (P₁₈) to perform speech recognition functions as the corresponding driver assist control function.

In a similar vein, the method 100 may be used to improve the available accuracy and/or detection speed of a driver monitoring system (DMS) device 60 having one or more cameras 62 disposed thereon. Such cameras 62 may operate at a required resolution and in an application-specific, eye-safe frequency range. Output images (arrow 160) may be fed from the DMS device 60 into a corresponding processing block, e.g., a facial expression recognition (FXR) block 44 or a gaze control (GZ) block 54, which in turn are configured to generate respective output files (arrows 144 and 154, respectively) and communicate the same to the DAS APPS block 40. Facial expressions can be used for various purposes, including for sentiment analysis. It is useful, for instance, for adapting voice user interface and feedback to the driver 18. A better estimate of user gaze and facial expression would therefore lead to more accurate classification of the user's sentiment.

Other vision-based applications may be used along with or instead of the representative F×R block 44 and GZC block 54 without departing from the intended scope of the present disclosure. Thus, the DAS device 11 of FIG. 1 may include the DMS 60 and an associated logic block, e.g., logic blocks 44 or 54, each configured to perform a corresponding facial expression or gaze tracking calculation, or another function, the results of which may be used to perform a corresponding driver assist control function by the DAS APPS block 40. Facial expression recognition could be used to capture emotional features and, via logic block 44, classifying the emotion in a more accurate manner. Used in this manner, the inputs to logic block 44 may include still or video image captures, pitch and head pose information, facial expression features, etc. Facial expression functions could be supplemented with audio information from the microphone array 30A. One possible implementation includes using two levels of classification: (I) image-based facial classification, and (II) audio/speech/conversation-based classification. In both cases, knowledge of the 3D head position (P₁₈) from the present method 100 may be used to locate the driver 18 within the passenger compartment 16, which in turn improves the accuracy of the two-variant classification.

As an example, a calculated line of sight determined in logic block 54 could be used by the DAS APP block 40 to detect or estimate possible distraction of the driver 18, with the DAS APP block 40 thereafter executing a control action responsive to the estimated alertness or distraction level, e.g., activating an alarm to alert the driver 18 and/or performing an autonomous control action such as steering or braking.

As noted above, the present method 100 is not limited to use with speech recognition and vision-based applications. For instance, one or more additional DAS devices 11X could be used aboard the motor vehicle 10 of FIGS. 1 and 2 outside of the context of speech and vision applications. The HUD device 28 and/or the height-adjustable seat belt assembly 24 are two possible embodiments of the additional DAS device 11X, with each including an associated control logic block 64 (CC_{X}) configured to adjust a setting thereof in response to the 3D driver head position (P₁₈). By way of example, an intensity, height/elevation, angle of screen orientation relative to the driver 18, size, font, and/or color could be adjusted based on the 3D driver head position (P₁₈), thereby optimizing performance of the HUD device 28.

Alternatively to or concurrently with operation of the HUD device 28, the associated control logic block 64 for the height-adjustable seat belt assembly 24 may output electronic control signals to raise or lower a shoulder harness other restraint to a more comfortable or suitable position. Other DAS devices 11X may be contemplated in view of the disclosure that may benefit from improved locational accuracy of the 3D driver head position (P₁₈), such as but not limited to possible deployment trajectories of airbags, positioning of a rear view mirror, etc., and therefore the various examples of FIG. 3 are illustrative of the present teachings and non-exclusive.

Those skilled in the art will recognize that the method 100 may be used aboard the motor vehicle 10 of FIGS. 1 and 2 as described above. An embodiment of the method 100 includes receiving, via the electronic controller 50, the position signals (arrow CC_{I}) inclusive of the sweep angle (α), the sweep angle (β), the elevation angle (γ), the predetermined distance (D), and the height (H). Such information may be communicated using a CAN bus, wirelessly, or via other transfer conductors. The method 100 includes calculating, using the set of position signals (arrow CC_{I}), the 3D head position (P₁₈) of the driver 18 of the motor vehicle 10 when the driver 18 is seated within the passenger compartment 16. Additionally, the method 100 includes transmitting the 3D head position (P₁₈) to the at least one DAS device 11, which is in communication with the electronic controller 50, to request execution of a corresponding driver assist control function aboard the motor vehicle 10.

In another aspect of the disclosure, the memory (M) of FIG. 1 is a computer readable medium on which instructions are recorded for localizing the 3D head position (P₁₈) of the driver 19. Execution of the instructions by at least one processor (P) of the electronic controller 50 causes the electronic controller 50 to perform the method 100. That is, execution of the instructions causes the electronic controller 50, via the processor(s) P, to receive the position signals (arrow CC_{I}) inclusive of the sweep angle (α) and the elevation angle (γ) of the driver side mirror 20D connected to the driver side 12D of the vehicle body 12 of FIGS. 1 and 2. The position signals (arrow CC_{I}) also include the second sweep angle (β) of the passenger side mirror 20P, the predetermined distance of separation (D) between mirrors 20D and 20P, and the current height (H) of the adjustable driver seat 19 shown in FIG. 1.

Additionally, the execution of the instructions causes the electronic controller 50 to calculate the 3D head position (P₁₈) using the position signals (arrow CC_{I}) when the driver 18 is seated within the passenger compartment 16, and to transmit the 3D head position (P₁₈) to the driver assist system (DAS) device(s) 11 for use in execution of a corresponding driver assist control function aboard the motor vehicle 10. Execution of the instructions in some embodiments causes the electronic controller 50 to transmit optimization request signals (arrow CC_{O}) to the DAS device(s) 11 concurrently with the 3D head position (P₁₈) to thereby request use of the 3D head position (P₁₈) in an optimization subroutine of the DAS device(s) 11.

As will be appreciated by those skilled in the art in view of the foregoing disclosure, the method 100 of FIG. 3 when used aboard the motor vehicle 10 of FIGS. 1 and 2 helps optimize driver assist functions by providing accurate knowledge of the 3D driver head position (P₁₈), which in turn is derived from existing positions information of the driver side mirror 20D, the passenger side mirror 20P, and the adjustable driver seat 19 rather than being remotely detected or sensed. Representative improvements described above include a reduced word error rate relative to properly tuned speech recognition software using the microphone array 30A. Using the available information from the mirrors 20D and 20P and the adjustable driver seat 19 as described above, an acoustic beam from the microphone array 30A may be pointed directly at the source of speech, i.e., the mouth of the driver 18. Similar improvements in error rate may be enjoyed by greatly limiting the area of interest searched by the camera(s) 62 of FIG. 3 when attempting to detect the driver 18 and relevant facial features thereof using machine vision capabilities. Additionally, the rapid calculation of the 3D driver head position (P₁₈) could be used to support driver assist functions outside of the realm of speech and vision, with various alternatives set forth above. These and other attendant benefits will be readily appreciated by those of ordinary skill in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A motor vehicle comprising:
a vehicle body defining a passenger compartment, the vehicle body including a driver side and a passenger side;
a driver side mirror connected to the driver side of the vehicle body, the driver side mirror having a sweep angle (α) and an elevation angle (γ);
a passenger side mirror connected to the passenger side of the vehicle body and having a sweep angle (β), wherein the passenger side mirror is separated from the drive side mirror by a distance of separation (D);
an adjustable driver seat connected to the vehicle body within the passenger compartment and having a height (H);
an electronic controller configured, in response to electronic position signals inclusive of the sweep angle (α), the sweep angle (β), the elevation angle (γ), the distance of separation (D), and the height (H), to calculate a three-dimensional (3D) driver head position of a driver of the motor vehicle when the driver is seated within the passenger compartment; and
at least one driver assist system (DAS) device in communication with the electronic controller and configured to execute a corresponding driver assist control function in response to the 3D driver head position.

2. The motor vehicle of claim 1, wherein the electronic controller is configured to output the 3D driver head position as a numeric triplet value [x, y, z] corresponding to an x-position (Pₓ), a y-position (P_{y}), and a z-position within a nominal xyz Cartesian frame of reference.

3. The motor vehicle of claim 2, wherein the electronic controller is configured to calculate the x-position (Pₓ) using the following equation:
$${P}_{x} = D \frac{tan ( β )}{tan ( α ) + tan ( β )}$$
and to calculate the y-position (P_{y}) as a function of the x-position (Pₓ).

4. The motor vehicle of claim 3, wherein the function of the x-position (Pₓ) is P_{y}=Pₓ tan(α), and the electronic controller is configured to calculate the z-position (P_{z}) as a function of the x-position (Pₓ).

5. The motor vehicle of claim 4, wherein the function of the x-position (Pₓ) is
$${P}_{z} = H + \frac{{P}_{x}}{cos ( α )} \cdot tan ( γ )$$

6. The motor vehicle of claim 1, further comprising a microphone array, wherein the at least one DAS device includes an acoustic beamforming block coupled to the microphone array and configured to process received acoustic signatures therefrom, wherein the acoustic beamforming block is configured to use the 3D driver head position to perform a speech recognition function as the corresponding driver assist control function.

7. The motor vehicle of claim 1, further comprising a driver monitoring system (DMS) having at least one camera positioned within the passenger compartment, wherein the at least one DAS device includes the DMS and an associated logic block configured to perform a gaze tracking and/or facial expression recognition function as the corresponding driver assist control function.

8. The motor vehicle of claim 1, further comprising a heads up display (HUD) device positioned within the passenger compartment, wherein the at least one DAS device includes the HUD device and an associated logic block configured to adjust a setting of the HUD device as the corresponding driver assist control function.

9. The motor vehicle of claim 1, further comprising a height-adjustable seat belt assembly mounted to the vehicle body within the passenger compartment, wherein the at least one DAS device includes the height-adjustable seat belt assembly and an associated logic block configured to adjust a height of the height-adjustable seat belt assembly as the corresponding driver assist control function.

10. The motor vehicle of claim 1, wherein the motor vehicle is characterized by an absence of a driver monitoring system (DMS).

11. A method for use aboard a motor vehicle having a vehicle body defining a passenger compartment, the vehicle body including driver side mirror connected to a driver side of the vehicle body and having a sweep angle (α) and an elevation angle (γ), a passenger side mirror connected to a passenger side of the vehicle body, having a sweep angle (β), and separated from the driver side mirror by a distance of separation (D), and an adjustable driver seat connected to the vehicle body within the passenger compartment and having a height (H), the method comprising:
receiving, via an electronic controller, a set of position signals inclusive of the sweep angle (α), the sweep angle (β), the elevation angle (γ), the distance (D), and the height (H);
calculating, using the set of position signals, a three-dimensional (3D) driver head position of a driver of the motor vehicle when the driver is seated within the passenger compartment; and
transmitting the 3D driver head position to at least one driver assist system (DAS) device in communication with the electronic controller to thereby request execution of a corresponding driver assist control function aboard the motor vehicle.

12. The method of claim 11, wherein calculating the 3D driver head position includes calculating a numeric triplet value [x, y, z] corresponding to an x-position (Pₓ), a y-position (P_{y}), and a z-position (P_{z}) within a nominal xyz Cartesian frame of reference.

13. The method of claim 12, wherein calculating the 3D driver head position includes calculating the x-position (Pₓ) using the following equation:
$${P}_{x} = D \frac{tan ( β )}{tan ( α ) + tan ( β )}$$
and calculating the y-position (P_{y}) as a function of the x-position (Pₓ), wherein the function of the x-position (Pₓ) is P_{y}=Pₓ tan(α).

14. The method of claim 13, further comprising calculating the z-position (P_{z}) as a function of the x-position (Pₓ) using the following equation:
$${P}_{z} = H + \frac{{P}_{x}}{cos ( α )} \cdot tan ( γ )$$

15. The method of claim 12, wherein transmitting the 3D driver head position to the at least one DAS device includes transmitting the 3D driver head position to an acoustic beamforming block coupled to a microphone array to thereby cause the at least one DAS device to perform a speech recognition function, using the 3D driver head position, as the corresponding driver assist control function.

16. The method of claim 12, wherein transmitting the 3D driver head position to the at least one DAS device includes transmitting the 3D driver head position to a logic block associated with a driver monitoring system (DMS) having at least one camera positioned within the passenger compartment, the at least one DMS device including the DMS, to thereby cause the DMS to perform a gaze tracking function and/or facial expression recognition function as the corresponding driver assist control function.

17. A computer readable medium on which instructions are recorded for localizing a three dimensional (3D) driver head position of a driver of a motor vehicle, wherein execution of the instructions by at least one processor of an electronic controller causes the electronic controller to:
receive a set of position signals inclusive of a sweep angle (α) and an elevation angle (γ) of a driver side mirror connected to a driver side of a vehicle body of the motor vehicle, a sweep angle (β) of a passenger side mirror connected to a passenger side of the vehicle body, a distance of separation (D) between the driver side mirror and the passenger side mirror, and a height (H) of an adjustable driver seat;
calculate the 3D driver head position using the set of position signals when the driver is seated within a passenger compartment of the motor vehicle; and
transmit the 3D driver head position to at least one driver assist system (DAS) device of the motor vehicle for use in executing a corresponding driver assist control function aboard the motor vehicle.

18. The computer readable medium of claim 17, wherein execution of the instructions causes the electronic controller to transmit an optimization request signal to the at least one DAS device concurrently with the 3D driver head position to thereby request use of the 3D driver head position in an optimization subroutine of the at least one DAS device.

19. The computer readable medium of claim 17, wherein execution of the instructions causes the electronic controller to calculate the 3D driver head position as a numeric triplet value [x, y, z] corresponding to an x-position (Pₓ), a y-position (P_{y}), and a z-position (P_{z}) within a nominal xyz Cartesian frame of reference.

20. The computer readable medium of claim 19, wherein execution of the instructions causes the electronic controller to respectively calculate the x-position (Pₓ), the y-position (P_{y}), and the z-position (P_{z}) using the following equations:
$${P}_{x} = D \frac{tan ( β )}{tan ( α ) + tan ( β )}$$
$${P}_{y} = {P}_{x} tan ( α ) , and$$
$${P}_{z} = H + \frac{{P}_{x}}{cos ( α )} \cdot tan ( γ )$$
